(19) United States
(12) Patent Application Publication
(10) Pub. No.: US 2010/0002048 A1
(43) Pub. Date: Jan. 7, 2010

(54) WASTE TREATMENT SYSTEM AND IMAGE FORMING APPARATUS

(75) Inventor: Shingo MASAOKA, Chigasaki City (JP)

Correspondence Address: COOPER & DUNHAM, LLP, 30 Rockefeller Plaza, 20th Floor, NEW YORK, NY, 10112, US

(73) Assignee: RICOH COMPANY, LTD., Tokyo (JP)

(21) Appl. No.: 12/495,937

(22) Filed: Jul. 1, 2009

(30) Foreign Application Priority Data
Jul. 2, 2008 (JP) 2008-173239
Feb. 12, 2009 (JP) 2009-030155

(51) Int. Cl. B41J 2/165

(52) U.S. Cl. 347/36

(57) ABSTRACT

A waste ink treatment system employed for an ink jetting system having a jetting head includes a rotating member and a scraping member. The rotating member, rotatable in a given rotation direction, receives ink discharged from the jetting head. The discharged ink adheres to the rotating member. The scraping member, disposed adjacent to the rotating member, removes the discharged ink adhering to the rotating member while the rotating member is rotated. The scraping member disperses the removed ink over multiple discontinuous areas along the rotation direction of the rotating member.

### CROSS-REFERENCE TO RELATED APPLICATIONS

This application claims priority to Japanese Patent Application No. 2008-173239, filed on Jul. 2, 2008, and No. 2009-030155, filed on Feb. 12, 2009 in the Japan Patent Office, the entire contents of each of which are hereby incorporated by reference herein.

### BACKGROUND OF THE INVENTION

1. Field of the Invention

The present invention relates to an image forming apparatus employing a waste ink treatment system to treat waste ink such as recording liquid jetted from a jetting head.

2. Description of the Background Art

Ink jet printing apparatuses using one or more ink jetting heads for image forming operations typically conduct a dummy discharge operation, involving a discharge of ink or some other recording liquid to prevent or clear clogging of one or more nozzles of the ink jetting head in order to maintain good nozzle performance. When such dummy discharge operation is conducted, the discharged ink may need to be treated as waste ink. A description is now given of a treatment of such waste ink.

In one configuration of an ink jet printing apparatus, a waste ink tank for storing waste ink is disposed at a non-printing area of the ink jet printing apparatus. When a dummy discharge operation is carried out, an ink jetting head is moved over the waste ink tank. In such configuration, ink, which is generally fast-dry material, may be discharged at a same position in the waste ink tank. Accordingly, discharged ink may accumulate at a discharged position and form a shape like a mound. If such mound of accumulated ink protrudes from an opening in the waste ink tank through which it was discharged into the tank in the first place, the accumulated ink may contact the ink jetting head and cause failures such as jetting malfunction or scratched images.

In light of such failures, another configuration is devised in which dummy discharged ink is received and transported by a rotating member or a belt conveyer. In such configuration, the rotating member or belt conveyer is rotated to transport the dummy discharged ink to a scraping member that scrapes the ink off the rotating member or belt conveyer and deposits it at a given distance from the discharging position of the ink jetting head, thus preventing the accumulated ink from contacting the ink jetting head directly. Such rotating member or belt conveyer system is exemplified by JP-3527312-B.

However, even with the above-described configuration, waste ink may be accumulated at a same one position in the waste ink tank, by which waste ink such as ink may accumulate in a mound and contact the rotating member or belt conveyer. If such a condition occurs, ink may not be scraped off the rotating member but instead may accumulate on the rotating member, or ink accumulation position may be clogged, for example. Then, such accumulated ink may resultantly contact an ink jetting head, or ink may intrude into and get stuck in a drive mechanism, causing the apparatus to fail.

If such apparatus failure occurs, a unit for receiving discharged ink may need to be replaced as a whole. Accordingly, a dummy discharge receiver may need to be replaced as a whole, or a rotating member or belt conveyer may need to be replaced as a whole, by which apparatus operating cost is increased. Further, a relatively greater space may be required to arrange the belt conveyer, by which size of apparatus machine is increased, and thereby apparatus cost is increased.

In view of such problem, another configuration is further devised, in which a waste ink tank for storing waste ink can be replaced alone. FIG. 1 shows such configuration. As shown in FIG. 1, a rotating member is disposed under a position for dummy discharge operation, and discharged ink is initially received on a circumferential face of the rotatable member. As the rotating member rotates, ink adhering to the circumferential face of the rotatable member is scraped off by a scraping member provided under the rotating member. Then, the scraped ink is ejected to the waste ink tank disposed under the scraping member. The waste ink tank may be detachably mounted to an image forming apparatus or the like, and can be replaced when the waste ink tank becomes full of waste ink such as ink.

However, even in such configuration shown in FIG. 1, the scraping member cannot completely scrape all ink from the rotating member, and thereby the rotating member may have to wait until a next dummy discharge operation to be cleaned while some ink remains on the rotating member. The ink remaining on the rotating member may dry out or increase in viscosity, and become clogged until the next dummy discharge operation scrapes it away. Such clogged ink may be scraped from the rotating member during the next dummy discharge operation, and ink may drop to the same ink accumulation position in the waste ink tank and form a mound. If such mound of accumulated ink grows until it protrudes from the opening in the waste ink tank through which the ink was discharged in the first place, such accumulated ink may contact an ink jetting head, or ink may intrude into and get stuck in a drive mechanism, causing apparatus failure.

Accordingly, a service life of the waste ink tank may terminate prematurely when the height of the accumulated ink approaches the opening in the waste ink tank through which the ink was discharged in the first place, and the waste ink tank is replaced at the end of such service life. However, because ink accumulation speed is too fast because ink accumulate at a same one position, the service life of waste ink tank becomes too short compared to a service life of apparatus or other devices such as printer or ink jetting head. As a result, the waste ink tank may need to be replaced frequently (e.g., six to seven times during a single service life of the apparatus), thus increasing the operating cost of the apparatus.

### SUMMARY

In one aspect of the present invention, a waste ink treatment system employed for an ink jetting system having a jetting head includes a rotating member and a scraping member. The rotating member, rotatable in a given rotation direction, receives ink discharged from the jetting head. The discharged ink adheres to the rotating member. The scraping member, disposed adjacent to the rotating member, removes the discharged ink adhering to the rotating member while the rotating member is rotated. The scraping member disperses the removed ink over multiple discontinuous areas along the rotation direction of the rotating member.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 illustrates a side view of a conventional configuration for a waste ink treatment system;

FIG. 2 illustrates a perspective view of an image forming apparatus according to an example embodiment;

FIG. 3 illustrates a cross-sectional view of the image forming apparatus of FIG. 2;

FIG. 4 illustrates a plan view of printing section of the image forming apparatus of FIG. 2;

FIG. 5 illustrates a perspective view of printing section of the image forming apparatus of FIG. 4;

FIG. 6 illustrates a plan view of a refreshing unit of the image forming apparatus of FIG. 2;

FIG. 7 illustrates a cross-sectional view of the refreshing unit of the image forming apparatus of FIG. 2;

FIG. 8 illustrates a side view of the refreshing unit of FIG. 6;

FIG. 9 illustrates a side view of configuration of a waste ink treatment system according to a first exemplary embodiment;

FIG. 10 illustrates a perspective view of waste ink treatment system of FIG. 9, in which an arrangement position of scraping members is shown;

FIG. 11 illustrates an expanded side view of waste ink treatment system of FIG. 9 showing an arrangement position of scraping members with respect to a rotating member;

FIG. 12 illustrates another perspective view of waste ink treatment system of FIG. 9 showing an arrangement position of scraping members with respect to a rotating member, in which the scraping members are fixed on a frame structure;

FIG. 13 illustrates an arrangement position of scraping member with respect to circumferential face of a rotating member;

FIG. 14 illustrates a bottom view of a rotating member disposed with a scraping member according to a second exemplary embodiment;

FIG. 15 illustrates a side view of the scraping member and the rotating member of FIG. 14;

FIG. 16 illustrates an arrangement position of scraping members with respect to circumferential face of a rotating member according to a third exemplary embodiment;

FIG. 17 illustrates a perspective view of arrangement position of scraping members with respect to circumferential face of a rotating member according to a fourth exemplary embodiment;

FIG. 18 illustrates an expanded view of an arrangement position of scraping members with respect to circumferential face of a rotating member of FIG. 17, in which the scraping members are disposed in a staggered manner in a rotation axis direction of the rotating member;

FIGS. 19A and 19B illustrate a schematic view of arrangement position of scraping members with respect to circumferential face of a rotating member according to a first exemplary embodiment;

FIGS. 19C and 19D illustrate a schematic view of arrangement position of scraping members with respect to circumferential face of a rotating member according to a fifth exemplary embodiment;

FIG. 20 illustrates a schematic side view of a waste ink tank according to a ninth exemplary embodiment;

FIG. 21 illustrates a bottom view of a rotating member according to a tenth exemplary embodiment;

FIG. 22 illustrates a schematic side view of a waste ink tank having a shutter mechanism according to an eleventh exemplary embodiment; and

FIG. 23 illustrates a schematic side view of a waste ink tank having a shutter mechanism according to a twelfth exemplary embodiment.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION OF EXEMPLARY EMBODIMENTS

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing expanded views shown in the drawings, specific terminology is employed for the sake of clarity, the present disclosure is not limited to the specific terminology so selected and it is to be understood that each specific element includes all technical equivalents that operate in a similar manner.

Referring now to the drawings, an image forming apparatus according to an exemplary embodiment is described. The image forming apparatus may employ inkjet system using ink for image forming operation, for example, but not limited thereto. Although the inkjet system using ink may be used for the following description, the present invention is not limited thereto. For example, a liquid jetting system using specifically prepared liquid can employ the configuration of the present invention, in which a given pattern may be formed on a substrate or the like by jetting liquid. Such liquid jetting system may include a semiconductor device manufacturing machine, a label forming machine but not limited thereto.

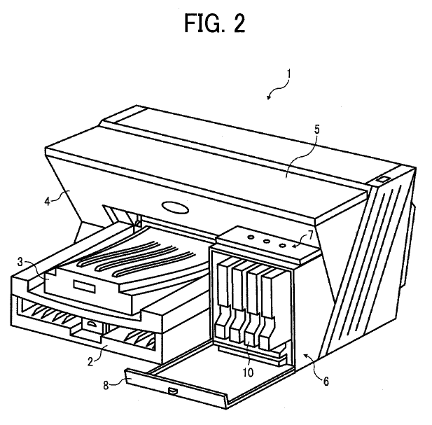

FIG. 2 illustrates a perspective view of an image forming apparatus 1 according to an exemplary embodiment. As shown in FIG. 2, the image forming apparatus 1 may include a sheet feed tray 2 and a sheet ejection tray 3. The sheet feed tray 2 is used to set a given volume of sheets, and the sheet ejection tray 3 is used to stack sheets that have recorded images thereon. The image forming apparatus 1 further includes a cartridge unit 6. The cartridge unit 6 may be projected to a front direction from one end of a front portion 4 of the image forming apparatus 1, and may be disposed lower than a top face 5 of the image forming apparatus 1. Further, an operation panel 7 may be disposed on a top face of the cartridge unit 6, wherein the operation panel 7 may include keys and a display panel, for example.

The cartridge unit 6 may include an ink cartridge 10, and a front cover B. The ink cartridge 10 is used as a main tank to store liquid to be supplied to a recording head. The ink cartridge 10 may be detachably mounted in the cartridge unit 6 so that ink cartridge 10 can be replaced with new cartridge. The front cover 8 can be opened and closed.

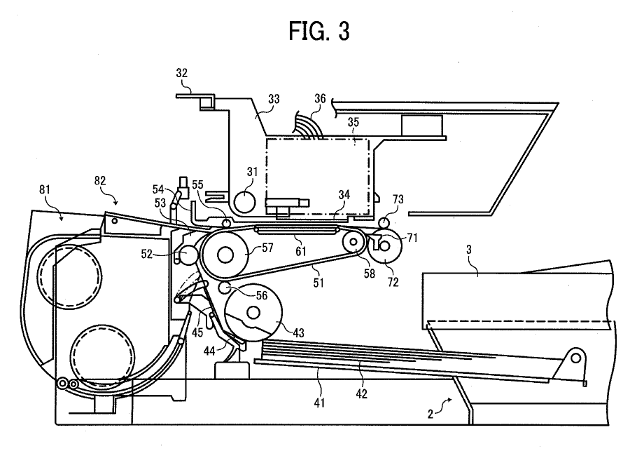

FIG. 3 illustrates a cross-sectional view of the image forming apparatus 1. First, a sheet feed section is described. The sheet feed section includes a sheet holder 41 to stack a given volume of sheet 42 in the sheet feed tray 2. The sheet 42 stacked on the sheet holder 41 is separated one by one using a sheet feed roller 43 having a half-moon shape. Further a separation pad 44 made of a material having a greater friction coefficient faces the sheet feed roller 43 while the separation pad 44 is pressed to the sheet feed roller 43.

Then, the sheet 42 is fed from the sheet feed section to a transport section, in which the sheet 42 is transported under a recording head 34.

The transport section may include a transport belt 51, a guide member 45, a counter roller 52, a transport guide 53, a pressure member 54, a pressure roller 55, and a charge roller 56, for example.

The sheet 42 is guided from the sheet feed section to the transport section using the guide member 45, and then further guided to a nip portion between the transport belt 51 and the counter roller 52. The transport guide 53 is used to change a sheet movement direction of the sheet 42 toward the transport belt 51, at which the sheet 42, transported in a substantially upward direction, and is fed to another direction for about 90 degrees. The pressure member 54 presses the pressure roller 55 toward the transport belt 51. The charge roller 56 charges a surface of the transport belt 51 at a given potential. The transport belt 51 transports the sheet 42 while attracting the sheet 42 using electrostatic force charged by the charge roller 56.

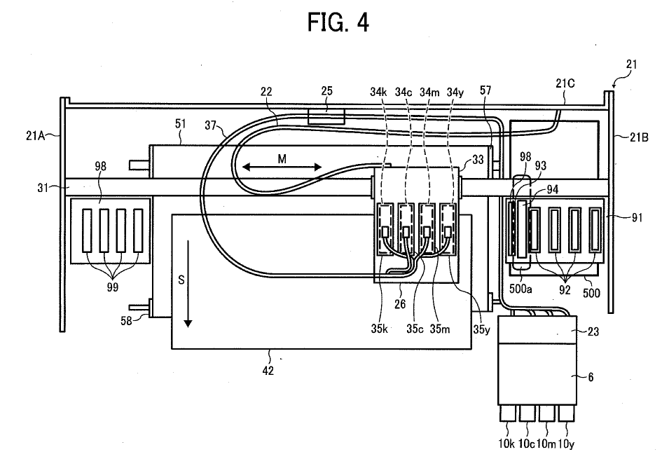

The transport belt 51 may be an endless belt extended by a transport roller 57 and a tension roller 58. The transport belt 51 can be traveled in a given direction as shown by an arrow S in FIG. 4 (referred to as belt moving direction). The charge roller 56 may contact a surface layer of the transport belt 51, and is rotated when the transport belt 51 rotates. Both end of the charge roller 56 may be pressed with a given force, such as 2.5 N (Newton).

Further, a guide device 61 is disposed at an inner face of the transport belt 51, wherein the guide device 61 faces a printing area of the recording head 34. The top face of the guide device 61 is positioned above the tangent line extended between the transport roller 57 and the tension roller 58. With such a configuration, the transport belt 51 can be pushed up by the guide device 61 at the printing area of the recording head 34, by which flatness of the transport belt 51 can be secured with higher precision.

Now, a sheet ejection section, which ejects the sheet 42 having an image recorded by the recording head 34, is described. The sheet ejection section may include a separation claw 71, an ejection roller 72, an ejection roller 73, for example. The separation claw 71 separates the sheet 42 from the transport belt 51. The sheet ejection tray 3 is disposed under the ejection roller 72. A height from the ejection roller 72 or the ejection roller 73 to the sheet ejection tray 3 is set to a given distance so that a given volume of sheets can be stacked on the sheet ejection tray 3.

Further, a sheet face-inverting unit 81 may be detachably mounted to a backside of the image forming apparatus 1. The sheet face-inverting unit 81 receives a sheet from the transport belt 51 when the transport belt 51 travels in an inverse direction, and the sheet face-inverting unit 81 inverts a face of the sheet 42, and then feeds the face-inverted sheet to the nip set between the counter roller 52 and the transport belt 51. Further, a manual sheet feeder 82 may be disposed on the sheet face-inverting unit 81.

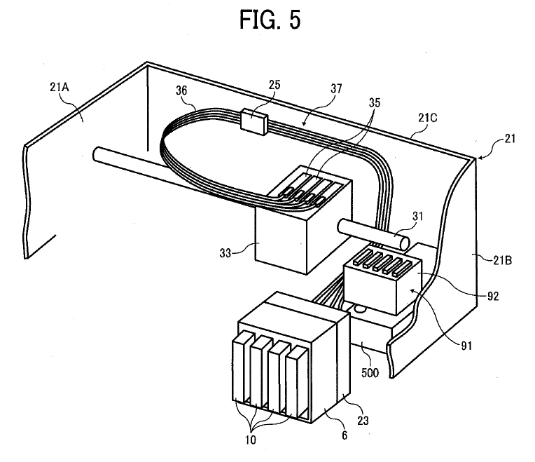

FIG. 4 illustrates a plan view of printing section of the image forming apparatus 1 shown in FIGS. 2 and 3. FIG. 5 illustrates a perspective view of printing section shown in FIG. 4.

As shown in FIG. 4, a frame 21 has a first side plate 21A and a second side plate 21B, and a guide rod 31 and a stay 32 extends between the first side plate 21A and the second side plate 21B as guide member of a carriage 33. Accordingly, the carriage 33 may slidably move in a main scanning direction along the guide rod 31. For example, the carriage 33 can move in a main scanning direction shown by an arrow M in FIG. 4 using a motor.

The carriage 33 may include an ink jetting head to jet recording liquid droplet (hereinafter, “ink”). For example, an ink jetting head may be consisted of a plurality of recording heads 34. The recording head 34 may have a plurality of nozzles arranged in a direction perpendicular to a main scanning direction, and ink can be jetted to a downward direction from the plurality of nozzles.

For example, the plurality of the recording heads 34 may include the recording head 34y for jetting yellow(Y) ink, the recording head 34m for jetting magenta(M) ink, the recording head 34c for jetting cyan(C) ink, and the recording head 34k for jetting black(K) ink. Such plurality of the recording head 34 may be referred “recording head 34.”

Further, the recording head 34 may have another configuration. For example, one recording head may have one nozzle array or a plurality of nozzle arrays, and may jet one color ink or a plurality of color ink from the nozzle array(s).

Such ink jetting head used for the recording head 34 may use known methods for jetting liquid droplets, such as a thermal method, a piezoelectric method, shape-memory-alloy actuator, and an electrostatic method. In the thermal method, an electricity-heat conversion element such as a heating resistor is used to cause a film boiling of liquid. In the piezoelectric method, an electricity-mechanical energy conversion element such as a piezoelectric element is used. In the shape-memory-alloy actuator, metal phase change caused by temperature change is used to jet liquid. In the electrostatic method, an electrostatic actuator, which generates electrostatic force, is used. Further, the recording head 34 is provided with a driver IC (integrated circuit), and is connected to a control unit using a harness 22 (e.g., FPC cable) as shown in FIG. 4.

Further, the carriage 33 may include sub-tanks 35y, 35m, 35c, and 35k to supply recording liquid of each color to the recording heads 34y, 34m, 34c, and 34k. Hereinafter, the sub-tanks 35y, 35m, 35c, and 35k may be referred to as “sub-tank 35.”

As shown in FIG. 5, the sub-tanks 35y, 35m, 35c, and 35k may be respectively connected to the ink cartridges 10y, 10m, 10c, and 10k via a liquid supply tube 37 so that recording liquid can be supplied to the sub-tank 35 from the ink cartridge 10. The liquid supply tube 37 may composed of four tubes 36, for example, wherein each of the four tubes 36 is used for different color inks respectively.

As shown in FIG. 4, the ink cartridge 10 is set in the cartridge unit 6, and the cartridge unit 6 includes a supply pump unit 23 to supply recording liquid in the ink cartridge 10 to the sub-tank 35.

Further, the liquid supply tube 37 running from the cartridge unit 6 to the sub-tank 35 is fixed on a third plate 21c of the frame 21 using a holder member 25 as shown in FIG. 5, and the liquid supply tube 37 is also fixed on the carriage 33 using a fixing rib 26.

Further, as shown in FIG. 4, a refreshing unit 91 is disposed at a non-printing area set at one end of scanning direction of the carriage 33. The refreshing unit 91 may include a mechanism to maintain and refresh nozzle performance condition of the recording head 34.

The refreshing unit 91 may include a cap 92, a wiper blade 93, a dummy discharge receiver 94, a wiper cleaner 95, and a cleaning roller 96, for example. The cap 92 may include the caps 92a to 92d to cap a nozzle face of each of the recording heads 34. The wiper blade 93 wipes the nozzle face of recording head 34. The dummy discharge receiver 94 receives ink, which is jetted to eject viscosity-increased recording liquid from the nozzle, wherein such dummy discharge of ink is conducted without forming an image. The wiper cleaner 95, integrally formed with the dummy discharge receiver 94, removes recording liquid adhered on the wiper blade 93. The cleaning roller 96 presses the wiper blade 93 to the wiper cleaner 95 when to clean the wiper blade 93. The refreshing unit 91 will be described later in detail.

Further, a waste ink tank 500 having an opening 500a is disposed under the refreshing unit 91 (see FIG. 9). The dummy discharge receiver 94 has a bottom side plate having an opening aligned to the opening 500a of the waste ink tank 500. Accordingly, when ink is dummy discharged to the dummy discharge receiver 94 or when the wiper blade 93 is cleaned to remove ink, such dummy discharged ink or removed ink is ejected to the waste ink tank 500 through the opening 500a of the waste ink tank 500. Further, the waste ink tank 500 may be detachably mounted to the image forming apparatus 1. For example, the waste ink tank 500 may be detachable through an opening formed on a rear side of the image forming apparatus 1, by which the waste ink tank 500 can be replaced easily.

Further, as shown in FIG. 4, at other non-printing area of the scanning direction of the carriage 33, another dummy discharge receiver 98 is arranged. Another dummy discharge receiver 98 receives dummy discharged ink, which is discharged during an image forming operation to eject viscosity-increased recording liquid from the nozzle. Another dummy discharge receiver 98 may include an opening 99 extending in a nozzle array direction of the recording head 34.

The image forming apparatus 1 shown in FIGS. 2 to 5 may be used as an inkjet recording machine, for example. A description is now given to an image forming operation to be conducted in the image forming apparatus 1 with reference to FIG. 3.

When the sheet 42 is fed from the sheet feed tray 2 one by one to the guide member 45, the sheet 42 is guided to an upward direction. Then, the sheet 42 is fed to a nip set between the transport belt 51 and the counter roller 52. With a guiding effect of the transport guide 53 and a pressure effect of the pressure roller 55, a transportation direction of the sheet 42 is changed for about ninety degrees, and then the sheet 42 is transported on the transport belt 51.

During such sheet transportation, a positive voltage and negative voltage current are supplied to the charge roller 56 from a high voltage power source alternately. Therefore, the transport belt 51 is alternately charged with positive and negative voltage, thereby positive voltage charged areas and negative voltage charged areas are formed on the transport belt 51 alternately. When the sheet 42 is fed on such charged transport belt 51, the sheet 42 is electro-statically adhered on the transport belt 51, and is transported to the recording section with a traveling of the transport belt 51.

As illustrated in FIG. 4, the carriage 33 having the recording head 34 can be moved in a main scanning direction shown by an arrow M over the sheet 42. The recording head 34 jets droplets (e.g., ink) onto the sheet 42 to record one line image on the sheet 42 when the carriage 34 moves in a direction shown by an arrow M. During an image forming operation, a transportation of the sheet 42 is stopped for recording one line image on the sheet 42. When the recording of one line image completes, the sheet 42 is transported for a given distance and another one line image is recorded on the sheet 42 by jetting droplets (e.g., ink) onto the sheet 42. Such recording process is repeated for one page. When such recording operation completes for one page, the sheet 42 is ejected to the sheet ejection tray 3.

Further, when an image forming operation is suspended, the carriage 33 may be moved to the refreshing unit 91, an then the cap 92 caps the recording head 34 to maintain nozzles at moist condition (or wet condition), by which jetting malfunction caused by dried ink can be prevented.

Further, while capping the recording head 34 with the cap 92, recording liquid may be sucked from nozzles (“nozzle suction” or “head suction”) to eject viscosity-increased recording liquid or gas bubble from nozzles, by which the recording head 34 can be refreshed to a good level of jetting performance.

Further, such dummy discharge of ink may be conducted for recording head 34 before starting an image forming operation, during an image forming operation to maintain good level of jetting performance of the recording head 34 over time.

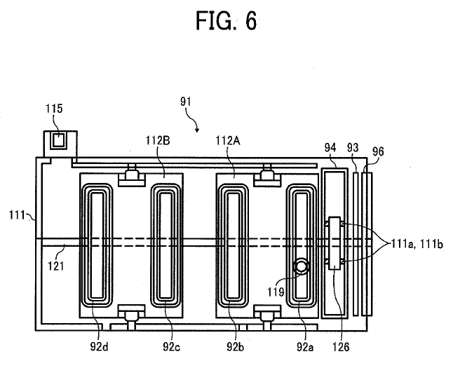

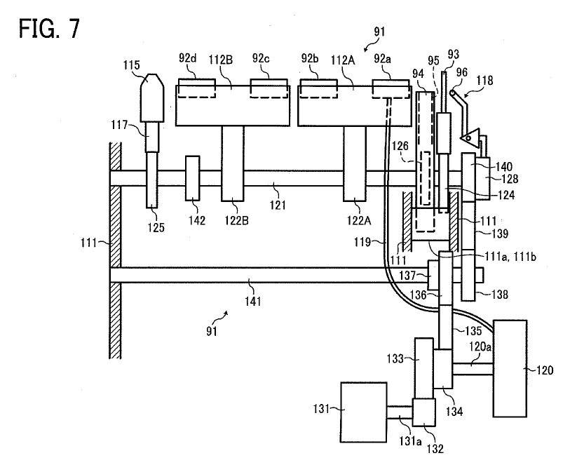

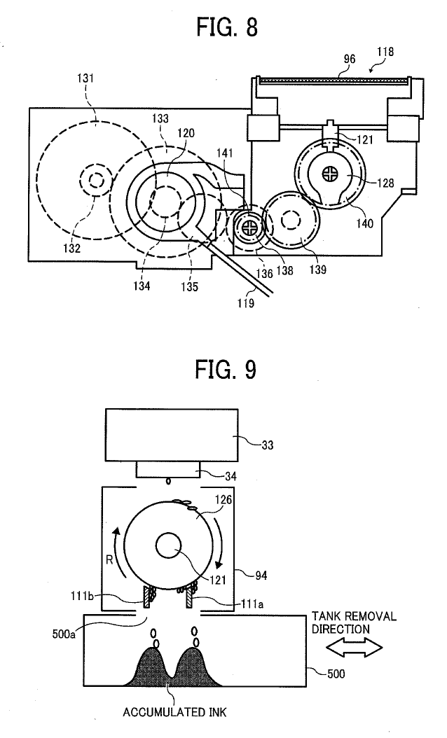

A description is now given to the refreshing unit 91 with reference to FIGS. 6 to 8. FIG. 6 illustrates a plan view of the refreshing unit 91. FIG. 7 illustrates a cross-sectional view of the refreshing unit 91. FIG. 8 illustrates a side view of refreshing unit 91 viewed from a right side in FIG. 7.

The refreshing unit 91 may include a frame structure 111, two cap holders 112A and 112B, the wiper blade 93 (used as a cleaning member made of elastic material), and a carriage lock 115, wherein the cap holders 112A and 112B, the wiper blade 93, and the carriage lock 115 can be moved in an upward and downward direction, which may be termed as “elevating motion.”

Further, the dummy discharge receiver 94 may be disposed between the wiper blade 93 and the cap holder 112A. Further, a wiper cleaning member 118 is swingably disposed next to the wiper blade 93. The wiper cleaning member 118 includes the cleaning roller 96 to be pressed to the wiper blade 93 to clean the wiper blade 93. As such, the wiper blade 93 may be disposed between the wiper cleaner 95 and the wiper cleaning member 118 as shown in FIG. 7.

The cap holder 112A includes the caps 92a and 92b, and the cap holder 112B includes the caps 92c and 92d so that the nozzle face of the recording heads 34 can be capped. The cap holders 112A and 112B may be referred to as “cap holder 112.”

As shown in FIG. 7, the cap 92a disposed in the cap holder 112A is connected to a tubing pump 120 (as a suction pump) via a flexible tube 119, but the caps 92b, 92c, and 92d may not be connected to the tubing pump 120. As such, the cap 92a is used as a moisture retention cap and a suction cap, and the other caps 92b, 92c, and 92d are only used as moisture retention cap. Accordingly, when to conduct refreshing operation of the recording head 34, one of the recording heads 34 that needs to be refreshed is moved to a position that can be capped by the cap 92a.

Further, a camshaft 121 is disposed under the cap holders 112A and 112B, wherein the camshaft 121 is rotatably supported by the frame structure 111. The camshaft 121 may be connected with cap cams 122A and 122B, a wiper cam 124, a carriage lock cam 125, a rotatable member 126, and a cleaner cam 128, for example.

The cap cams 122A and 122B are used to move the cap holders 112A and 112B in an upward and downward direction. The wiper cam 124 is used to move the wiper blade 93 in an upward and downward direction. The carriage lock cam 125 is used to move the carriage lock 115 in an upward and downward direction via a carriage lock arm 117. The rotatable member 126 is used to receive liquid droplet discharged as dummy ink in the dummy discharge receiver 94, in which liquid droplet may adhere to the rotating member 126. The cleaner cam 128 is used to swing the wiper cleaning member 118.

The cap 92 can be moved in an upward and downward direction using the cap cams 122A and 122B. The wiper blade 93 can be moved in an upward and downward direction using the wiper cam 124. When the wiper blade 93 is moved in a downward direction, the wiper cleaning member 118 swings toward the wiper blade 93. Then, the wiper blade 93 is moved in a downward direction while the wiper blade 93 is being sandwiched between the cleaning roller 96 of the wiper cleaning member 118 and the wiper cleaner 95 of the dummy discharge receiver 94. With such configuration, ink adhered on the wiper blade 93 can be scraped (or removed) and dropped in the dummy discharge receiver 94.

The carriage lock 115 is biased toward an upward direction (i.e., lock direction) by a compression spring. The carriage lock 115 can be moved in an upward and downward direction by using the carriage lock arm 117 driven by the carriage lock cam 125.

The tubing pump 120 and the camshaft 121 can be driven by using a motor 131. The motor 131 includes a motor shaft 131a having a motor gear 132 at the one end of the motor shaft 131a. The tubing pump 120 includes a pump shaft 120a having a pump gear 133 at the one end of the pump shaft 120a. The motor gear 132 and the pump gear 133 are meshed each other. Accordingly, a rotation movement of the motor shaft 131a is transmitted to the pump shaft 120a.

Further, a first intermediate gear 134 integrated with the pump gear 133 is meshed to a second intermediate gear 135, and the second intermediate gear 135 is meshed to a third intermediate gear 136 having an one-direction clutch 137. Further, the third intermediate gear 136 and a fourth intermediate gear 138 are attached on an intermediate gear shaft 141, and the fourth intermediate gear 138 is meshed to a fifth intermediate gear 139, and the fifth intermediate gear 139 is meshed to a cam gear 140 fixed on the camshaft 121. Further, the intermediate gear shaft 141 (used as a rotation shaft), to which the third intermediate gear 136 having the one-direction clutch 137 and the fourth intermediate gear 138 are fixed, is rotatably supported by the frame structure 111.

Further, the camshaft 121 is provided with a home position sensing cam 142 to detect a home position. The refreshing unit 91 includes a home position sensor (not shown). When the cap 92 is moved to the lowest position, a home position lever is activated, then the home position sensor is set to ON condition, by which a home position of the motor 131 or others (excluding the tubing pump 120) is detected.

Further, when a power is supplied to the image forming apparatus 1, the cap 92 (or cap holder 112) may be moved in an upward and downward direction at first without any consideration of position of the cap 92, which means a position detection is not conducted at the time when the cap 92 is started to move.

When a home position of the cap 92 is detected during a upward movement, the cap 92 is moved to the lowest position by moving the cap 92 for a given distance. Then, the carriage 33 is moved in a left and right direction for position detection and is returned to a capping position, by which the recording head 34 can be capped.

The image forming apparatus 1, which has the above-described configuration may include a waste ink treatment system. A description is now given to the waste ink treatment system according to exemplary embodiments.

A description is now given to first exemplary embodiment of the waste ink treatment system with reference to FIG. 9. FIG. 9 illustrates a schematic view of the waste ink treatment system according to a first exemplary embodiment. As shown in FIG. 9, the waste ink treatment system may include the dummy discharge receiver 94 and the waste ink tank 500, wherein the dummy discharge receiver 94 may receive dummy discharged ink or waste ink, and the waste ink tank 500 may be used to collect recovered ink.

The dummy discharge receiver 94 is disposed under a bottom side of the recording head 34 included in the carriage 33. The waste ink tank 500 is detachably mounted under the bottom side of the dummy discharge receiver 94. Further, the refreshing unit 91 has the upper side and the bottom side having openings. Further, the waste ink tank 500 has the upper side having an opening 500a.

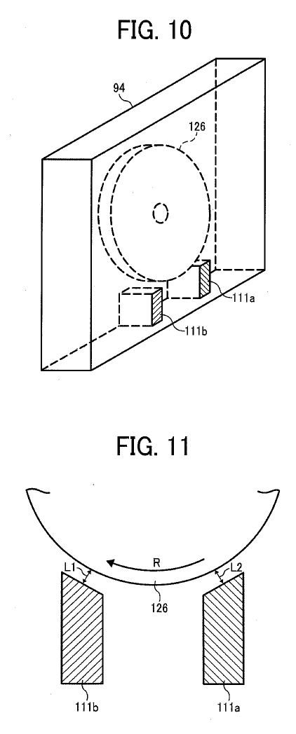

As shown in FIGS. 9 and 10, the dummy discharge receiver 94 may include the rotatable member 126, and first and second scraping members 111a and 111b, for example. The rotatable member 126 may rotate in a given direction about the camshaft 121 (used as rotation axis). For example, the rotatable member 126 may rotate in a clockwise direction as shown by an arrow R. The first and second scraping members 111a and 111b, disposed under the rotatable member 126, may be detachably mounted to an inner wall face of the dummy discharge receiver 94. Further, although two scraping members (i.e., first and second scraping members 111a and 111b) are employed in FIGS. 9 and 10, the number of scraping members may not limited to two, but three or more scraping members can be employed.

A description is now given to an arrangement position of the first and second scraping members 111a and 111b with reference to FIG. 11. As shown in FIG. 11, the two first and second scraping members 111a and 111b may be disposed along a rotation direction of the rotatable member 126 (see arrow R in FIG. 11) with a given distance interval. Further, the first and second scraping members 111a and 111b may have an edge portion facing a circumferential face of the rotatable member 126, wherein such edge portion is shaped in a slanted shape that can be matched to a curving of the circumferential face of the rotatable member 12. Ink may adhere to the circumferential face of the rotatable member 12.

Further, as shown in FIG. 11, the first scraping member 111a is distanced from the circumferential face of the rotatable member 126 by setting a distance L1, and the second scraping member 111b is distanced from the circumferential face of the rotatable member 126 by setting a distance L2. Such distance L1 and L2 may be provided to prevent sticking of the first and second scraping members 111a and 111b to the circumferential face of the rotatable member 126 caused by adhered ink on the rotatable member 126. In FIG. 11, the distance L1 and L2 may be set to a same distance (e.g., 0.5 mm to 1 mm). The first and second scraping members 111a and 111b may be preferably made of a material having a given level of strength because scraped (or removed) ink may adhere on the surface of the scraping member.

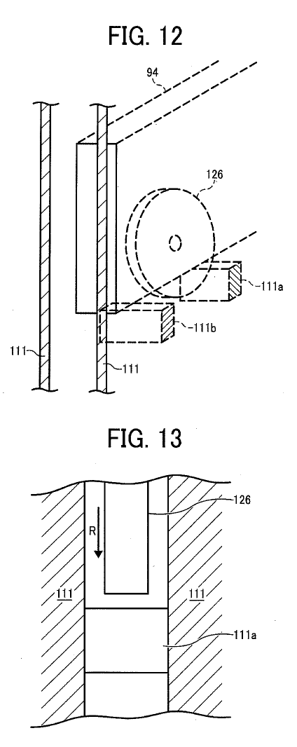

Further, although the first and second scraping members 111a and 111b may be disposed inside the dummy discharge receiver 94, the first and second scraping members 111a and 111b may be detachably mounted to a wall face of the frame structure 111 as shown in FIGS. 12 and 13. In FIGS. 12 and 13, the first and second scraping members 111a and 111b are disposed on the frame structure 111. FIG. 12 illustrates a perspective view of the first and second scraping members 111a and 111b disposed on a wall face of the frame structure 111, and the rotatable member 126 is disposed in the dummy discharge receiver 94. FIG. 13 illustrates a front view of the circumferential face of the rotatable member 126 shown in FIG. 12, and an arrangement position of the first scraping member 111a. As shown in FIGS. 7, 12, and 13, the scraping members 111a and 11b may be arranged under the rotatable member 126 while the first and second scraping members 111a and 111b are disposed (or attached) on the frame structure 111 as similar when the first and second scraping members 111a and 111b are disposed (or attached) in the dummy discharge receiver 94.

A description is now given to an ink recovery process using the above-described waste ink treatment system. At first, ink that is dummy discharged from the recording head 34 passes through an opening set for the upper side of the dummy discharge receiver 94, and impacts or adheres to the circumferential face of the rotatable member 126.

As the rotatable member 126a rotates, ink adhered on the rotatable member 126 (hereinafter “adhered ink”) may come to a position facing the first and second scraping members 111a and 111b disposed under the rotatable member 126. Adhered ink may be scraped (or removed) and dispersed by the first and second scraping members 111a and 111b. Such removed ink may disperse through an opening set for the bottom side of the dummy discharge receiver 94 and the opening 500a set for the upper side of the waste ink tank 500, and accumulate in the waste ink tank 500.

In the first exemplary embodiment, adhered ink can be removed for two times because two scraping members (i.e., first and second scraping members 111a and 111b) are employed. If ink is removed at two positions as shown in FIG. 9, the scraping members 111a and 111b can disperse the removed ink over multiple discontinuous areas (e.g., at least two areas) along the rotation direction of the rotating member. In FIG. 9, the removed ink may accumulated at least two areas positions along a rotation direction of the rotatable member 126 in the waste ink tank 500, but it should be noted that FIG. 9 only shows a schematic accumulation and the ink can be dispersed over multiple discontinuous areas along the rotation direction of the rotating member 126.

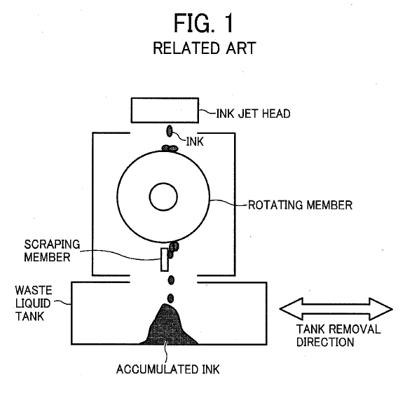

As above described, FIG. 1 shows a conventional configuration, in which one scraping member is employed, by which ink may accumulate at one portion in a waste ink tank. Accordingly, accumulated ink may pile up to top of an opening of the waste ink tank in a short time, by which replacement interval of waste ink tank may become shorter.

However, in the first exemplary embodiment, the waste ink treatment system may employ at least two scraping members as shown in FIG. 9. Further, the waste ink treatment system can employ more than two scraping members. Accordingly, the scraping members 111a and 111b can disperse the removed ink over multiple discontinuous areas along the rotation direction of the rotating member 126, by which ink accumulation speed can be set slower, and resultantly, replacement interval of waste ink tank 500 can be set longer, and the number of replacement operations can be reduced. Further, because the above described configuration for accumulating ink over multiple discontinuous areas along the rotation direction of the rotating member 126 can be realized with a simpler configuration, the size of machine or apparatus may not increase, and manufacturing cost may not increase.

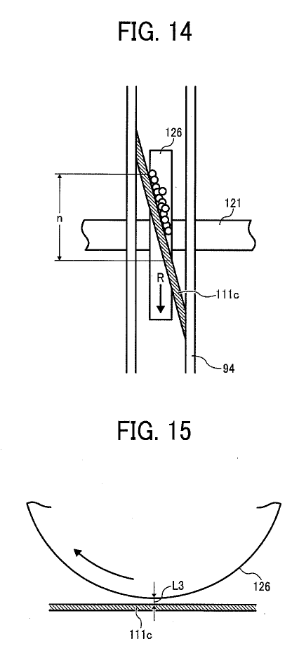

A description is now given to second exemplary embodiment of the waste ink treatment system with reference to FIG. 14. The configuration of waste ink treatment system for the second exemplary embodiment may have a similar configuration of the waste ink treatment system of the first exemplary embodiment shown in FIG. 9, but a configuration of scraping member is differentiated. In the first exemplary embodiment, a plurality of scraping members (e.g., first and second scraping members 111a and 111b) are employed to remove and disperse adhered ink over multiple discontinuous areas along the rotation direction of the rotating member 126. In the second exemplary embodiment, adhered ink is removed and dispersed over multiple discontinuous areas along the rotation direction of the rotatable member 126 using one scraping member (i.e., third scraping member 111c). The third scraping member 111c has a given shape to enable such dispersing and accumulation of ink as below described. FIG. 14 shows the third scraping member 111c viewed from a bottom side of the rotatable member 126.

As shown in FIG. 14, the third scraping member 111c, disposed under the rotatable member 126, may be angled with respect to the rotation direction (see arrow R in FIG. 14) of the rotating member 126, and may be extended for a given length along the rotation direction of the rotating member 126. Further, the third scraping member 111c may be detachably mounted to the inner wall faces of the dummy discharge receiver 94. Further, as shown in FIG. 15, the third scraping member 111c may be distanced from the circumferential face of the rotatable member 126 by setting a distance L3. As similar to the distance L1 and L2 shown in FIG. 11, the distance L3 may be preferably set to a given value (e.g., 0.5 mm to 1 mm). Further, as shown in FIG. 14, the third scraping member 111c may scrape and disperse adhered ink from the circumferential face of the rotatable member 126 at an area having a given length “n.” The length n is preferably set to a value equal to or greater than a radius of the rotatable member 126, for example. The greater the length n, the better for removing ink because if the length n is greater, adhered ink can be removed and dispersed over multiple discontinuous areas along the rotation direction of the rotatable member 126 while shortening an interval of adjacent discontinuous areas because the third scraping member 111c extends for the given length n along the rotation direction of the rotatable member 126.

As such, adhered ink can be removed and dispersed over multiple discontinuous areas along the rotation direction of the rotatable member 126 while shortening an interval of adjacent discontinuous areas. Accordingly, in the waste ink tank 500, accumulated ink may form a mound having a smooth slope. Accordingly, the accumulated ink may not piled up to one portion, and ink accumulation speed can be set slower, and resultantly, a replacement interval of waste ink tank can be set longer. Further, although the third scraping member 111c may have a straight shape, for example, the third scraping member 111c may have a curved shape matched to the circumferential face of the rotatable member 126. Further, although the third scraping member 111c may be disposed in the dummy discharge receiver 94, the third scraping member 111c may be detachably mounted to the frame structure 111.

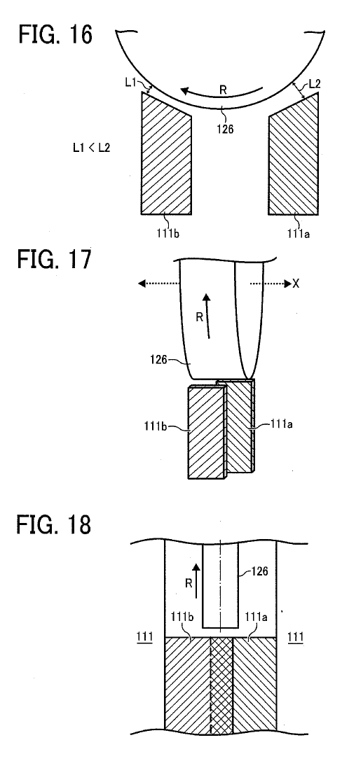

A description is now given to third exemplary embodiment of the waste ink treatment system with reference to FIG. 16. The configuration of waste ink treatment system for the third exemplary embodiment may have a similar configuration of the waste ink treatment system of the first exemplary embodiment shown in FIG. 9, but an arrangement position of the first scraping member 111a is differentiated. FIG. 16 shows an arrangement position of the first and second scraping members 111a and 111b.

As shown in FIG. 16, the first and second scraping members 111a and 111b are disposed under the rotatable member 126 along a rotation direction of the rotatable member 126 (see an arrow R in FIG. 16) as similar to the first exemplary embodiment. In the third exemplary embodiment, a distance between the first scraping member 111a and the circumferential face of the rotatable member 126, and a distance between the second scraping member 111b and the circumferential face of the rotatable member 126 may be set to different values.

For example, the distance between the second scraping member 111b and the circumferential face of the rotatable member 126 may be set to a distance L1, and the distance between the first scraping member 111a and the circumferential face of the rotatable member 126 may be set to a distance L2, and L2 is set greater than L1 (L2>L1), which means the first scraping member 111a is set at a position far from the circumferential face of the rotatable member 126 compared to the second scraping member 111b. In other words, one scraping member 111 is set far from the rotatable member 126 at an upstream of rotation direction of the rotatable member 126, and another scraping member 111 is set closer to the rotatable member 126 at a downstream of rotation direction of the rotatable member 126.

As such, as shown in FIG. 16, at a upstream of rotation direction of the rotatable member 126, the distance between the first scraping member 111a and the circumferential face of the rotatable member 126 may be set to a greater distance (see L2); at a downstream of rotation direction of the rotatable member 126, the distance between the second scraping member 111b and the circumferential face of the rotatable member 126 is set to a smaller distance (see L1).

In the first exemplary embodiment, L1 and L2 are set to a same distance as shown in FIG. 11. In such a case, ink amount that can be removed and dispersed by the first scraping member 111a and ink amount that can be removed and dispersed by the second scraping member 111b may not be set evenly because the first scraping member 111a may scrape greater amount of ink compared to the second scraping member 111b.

In the third exemplary embodiment, L1 and L2 are set to different values, by which ink amount that can be removed and dispersed by the first scraping member 111a and ink amount that can be removed and dispersed by the second scraping member 111b may be set evenly. Accordingly, ink accumulation speed can be set to a substantially same speed at different ink accumulation positions dispersed in the waste ink tank 500. As a result, a replacement interval of waste ink tank 500 can be set longer.

A description is now given to fourth exemplary embodiment of the waste ink treatment system with reference to FIGS. 17 and 18. The configuration of waste ink treatment system for the fourth exemplary embodiment may have a similar configuration of the waste ink treatment system of the first exemplary embodiment shown in FIG. 9, but an arrangement position of the first and second scraping members 111a and 111b is differentiated. FIG. 17 illustrates a perspective view of an arrangement position of the first and second scraping members 111a and 111b for the fourth exemplary embodiment scraping member. FIG. 18 illustrates a front view of the circumferential face of the rotatable member 126 shown in FIG. 17.

The first and second scraping members 111a and 111b shown in FIGS. 17 and 18 are arranged in a staggered manner in a rotation axis direction (see arrow X in FIG. 17) of the rotatable member 126. As also shown in FIG. 18, the first and second scraping members 111a and 111b are arranged in a staggered manner. The first and second scraping members 111a and 111b may be detachably mounted to one of wall faces of the frame structure 111. Further, as shown in FIG. 18, although the first and second scraping members 111a and 111b may be disposed on the frame structure 111, the first and second scraping members 111a and 111b may be disposed in the dummy discharge receiver 94. Further, although the first and second scraping members 111a and 111b are distanced from the circumferential face of the rotatable member 126 for a same distance as shown in FIG. 18 as similar to FIG. 11, the first and second scraping members 111a and 111b may be distanced from the circumferential face of the rotatable member 126 by setting different distance as shown in FIG. 16.

As such, ink removing position can be set in a staggered manner in a rotation axis direction (see an arrow X in FIG. 17) of the rotatable member 126 as above described. Accordingly, ink accumulation speed can be set to a substantially same speed at different ink accumulation positions, which are multiple discontinuous areas along the rotation direction of the rotating member 126, in the waste ink tank 500. As a result, a replacement interval of waste ink tank 500 can be set longer.

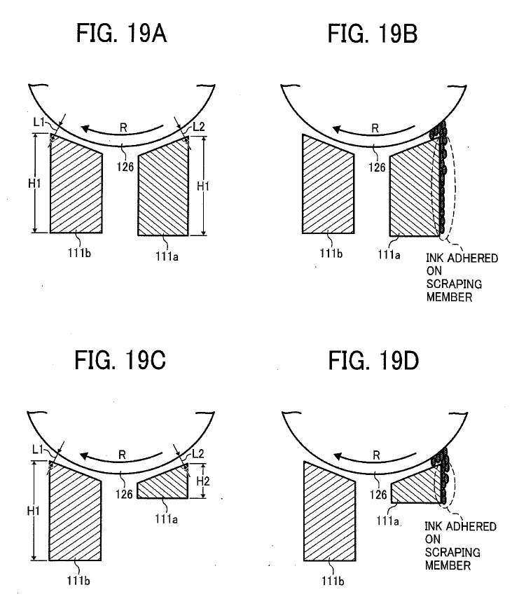

A description is now given to fifth exemplary embodiment of the waste ink treatment system with reference to FIG. 19. The configuration of waste ink treatment system for the fifth exemplary embodiment may have a similar configuration of the waste ink treatment system of the first exemplary embodiment shown in FIG. 9, but a height of the first scraping members 111a is differentiated. For example, a height of scraping member positioned at an upstream of rotation direction of the rotatable member 126 is set shorter, by which a side face area of the scraping member set smaller, and thereby ink amount adhered on the side face of the scraping member can be set smaller.

FIG. 19A shows a configuration of the first exemplary embodiment (see FIG. 11), in which the first scraping member 111a is positioned at an upstream side of a rotation direction of the rotatable member 126 and the second scraping member 111b is positioned at a downstream side of a rotation direction of the rotatable member 126, and the first and second scraping members 111a and 111b may have a same height H1. In such a configuration shown in FIG. 19A, when the first scraping member 111a removes and disperses ink from the rotatable member 126, ink may adhere on a side face of the first scraping member 111a as shown in FIG. 19B. Accordingly, the greater the side face area of the first scraping member 111a, the greater the ink amount adhering the side face of the first scraping member 111a.

In the fifth exemplary embodiment, a configuration shown in FIG. 19C is used, for example. In a configuration of FIG. 19C, a height H2 of the first scraping member 111a positioned at an upstream side of a rotation direction of the rotatable member 126 is set smaller than a height H1 of the second scraping member 111b positioned at a downstream side of a rotation direction of the rotatable member 126. The height H2 may be set to given value (e.g., 2 mm) by forming the first scraping member 111a like a rib shaped form, for example, but not limited thereto. Accordingly, a side face area of the first scraping member 111a shown in FIG. 19C can be set smaller than a side face area of the first scraping member 111a shown in FIG. 19A.

Ink adhered to the circumferential face of the rotatable member 126 is removed and dispersed by the first scraping member 111a, and then such removed ink may adhere on the first scraping member 111a as shown in FIG. 19D. However, adhered ink amount shown in FIG. 19D can be set smaller than adhered ink amount shown in FIG. 19B. Accordingly, adhered ink amount on the first scraping member 111a can be reduced for the fifth exemplary embodiment. Accordingly, re-adhering of ink from the first scraping member 111a to the rotatable member 126 can be prevented or reduced.

Further, although the height of first scraping member 111a a lone is set smaller, a height of the second scraping member 111b can be set smaller as similar to the first scraping member 111a, for example. If both of the first and second the scraping members 111a and 111b have the smaller height H2, re-adhering of ink from the first and second the scraping members 111a and 111b to the rotatable member 126 can be prevented or reduced more effectively compared to setting a smaller height to only one of the scraping members 111a and 111b.

A description is now given to sixth exemplary embodiment of the waste ink treatment system. The configuration of waste ink treatment system for the sixth exemplary embodiment may have a similar configuration of the waste ink treatment system for the above-described exemplary embodiments, but a diameter of the rotatable member 126 is set greater. By using such rotatable member 126 having a greater diameter, scraping members can be positioned at multiple positions along the rotation direction of the rotating member 126, by which ink accumulation positions in the waste ink tank 500 can be dispersed over multiple discontinuous areas along the rotation direction of the rotating member 126, by which a replacement interval of the waste ink tank 500 can be set longer.

A description is now given to a seventh exemplary embodiment of the waste ink treatment system. The configuration of waste ink treatment system for the seventh exemplary embodiment may have a similar configuration of the waste ink treatment system for the above-described exemplary embodiments, but the first and second scraping members 111a and 111b may be formed integrally with the frame structure 111 for the seventh exemplary embodiment instead of detachable mounting to the first and second scraping members 111a and 111b. Specifically, in a configuration shown in at least in FIGS. 7, 12, FIG. 13, the frame structure 111 and the first and second scraping members 111a and 111b are integrated as one unit, by which the number of parts can be reduced and manufacturing cost can be reduced. Such integration process may be conducted by a molding process, for example.

A description is now given to an eighth exemplary embodiment of the waste ink treatment system. The configuration of waste ink treatment system for the eighth exemplary embodiment may have a similar configuration of the waste ink treatment system for the above-described exemplary embodiments, but the first and second scraping members 111a and 111b are integrally formed with the dummy discharge receiver 94 for the eighth exemplary embodiment instead of detachablly mounting the first and second scraping members 111a and 111b. Specifically, in a configuration shown in at least in FIGS. 6, 9, and 10, the dummy discharge receiver 94 and the first and second scraping members 111a and 111b are integrated as one unit, by which the number of parts can be reduced and manufacturing cost can be reduced. Such integration process may be conducted by a molding process, for example.

In the above described seventh exemplary embodiment, the first and second scraping members 111a and 111b and the frame structure 111 are integrated as one unit. In such a configuration, if the first scraping member 111a is damaged by ink sticking phenomenon, the refreshing unit 91 may need to be replaced as a whole because the frame structure 111 may configure a part of body of the refreshing unit 91.

However, in the eighth exemplary embodiment, even if the first scraping member 111a is damaged, the first scraping member 111a can be replaced with new one just replacing the dummy discharge receiver 94, which can be separated from the refreshing unit 91 as one sub-unit, by which replacement cost can be reduced, and maintenance work can be efficiently conducted.

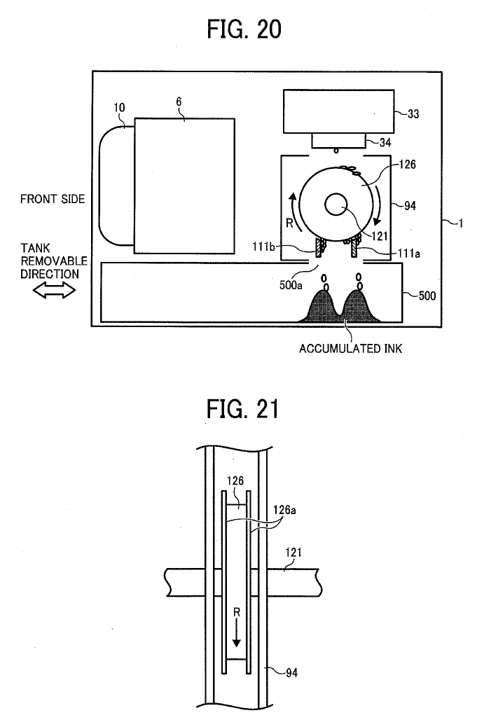

A description is now given to a ninth exemplary embodiment of the waste ink treatment system with reference to FIG. 20. The configuration of waste ink treatment system for the ninth exemplary embodiment may have a similar configuration of the waste ink treatment system for the above-described exemplary embodiments, but the waste ink tank 500 can be detachably mounted to the image forming apparatus 1 from a front side of the image forming apparatus 1 as shown in FIG. 20, by which the waste ink tank 500 can be replaced efficiently.

A description is now given to a tenth exemplary embodiment of the waste ink treatment system with reference to FIG. 21. The configuration of waste ink treatment system for the tenth exemplary embodiment may have a similar configuration of the waste ink treatment system for the above-described exemplary embodiments, but the rotatable member 126 has a differentiated shape as shown in FIG. 21, in which the rotatable member 126 is viewed from a bottom side, and scraping members are omitted from drawing.

As shown in FIG. 21, in the tenth exemplary embodiment, the rotatable member 126 may have a peripheral flange 126a on its peripheral portion, which is a circumferential face of the rotatable member 126. With such a configuration, dummy discharged ink can be effectively received by the circumferential face of the rotatable member 126; sputtering of ink to the frame structure 111 can be prevented or reduced; and ink accumulation between the rotatable member 126 and the frame structure 111 can be prevented or reduced. Further, the rotatable member 126 may have the peripheral flange 126a on its one peripheral side or both peripheral sides. Preferably, the flange portion 126a may be provided on the both peripheral sides of the rotatable member 126.

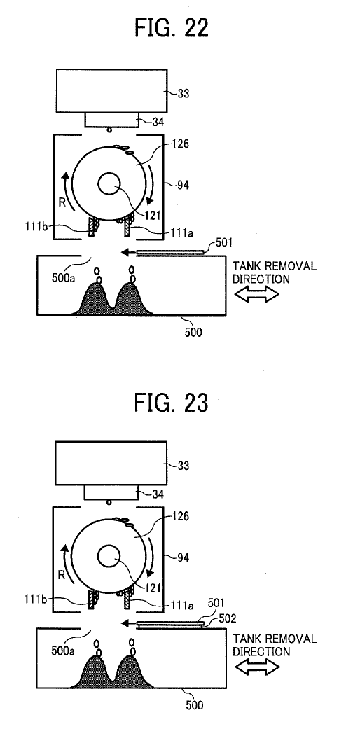

A description is now given to an eleventh exemplary embodiment of the waste ink treatment system with reference to FIG. 22. The configuration of waste ink treatment system for the eleventh exemplary embodiment may have a similar configuration of the waste ink treatment system for the above-described exemplary embodiments, but the waste ink tank 500 has a shutter mechanism as shown in FIG. 22.

As shown in FIG. 22, the waste ink tank 500 includes a tank shutter 501 to cover the opening 500a of the waste ink tank 500. The tank shutter 501 can be opened and closed over the opening 500a. For example, when the waste ink tank 500 is mounted in the image forming apparatus 1, the tank shutter 501 is set to an open position so that the opening 500a can be set to a opened condition; when the waste ink tank 500 is removed from the image forming apparatus 1, the tank shutter 501 is set to a close position so that the opening 500a is closed by the tank shutter 501. The open/close movement of the tank shutter 501 may be controlled by a control unit that can detect a mounting/removing operation of the waste ink tank 500. With such a configuration, a spillover of ink from the waste ink tank 500 during a replacement work of the waste ink tank 500 can be prevented.

A description is now given to a twelfth exemplary embodiment of the waste ink treatment system with reference to FIG. 23. The configuration of waste ink treatment system for the twelfth exemplary embodiment may have a similar configuration of the waste ink treatment system for the eleventh exemplary embodiment, but the waste ink tank 500 has another shutter mechanism as shown in FIG. 23.

As shown in FIG. 23, the tank shutter 501 is provided with an absorber 502 on a bottom of the tank shutter 501, wherein the absorber 502 is contactable with an outer face of the waste ink tank 500. With such a configuration, a spillover of ink from the waste ink tank 500 during a replacement work of the waste ink tank 500 can be prevented more effectively.

Further, the above-described first to twelfth exemplary embodiments can be used alone or in any combinations, and such exemplary embodiments can be employed for an image forming apparatus such as for example inkjet printing apparatus.

An image forming apparatus employing a waste ink treatment system according to the above-described exemplary embodiments can accumulate dummy discharged ink or removed ink in the waste ink tank 500 over multiple discontinuous areas along the rotation direction of the rotating member 126), by which replacement interval of the waste ink tank 500 can be set longer. Further, the waste ink treatment system according to the above-described exemplary embodiments may not need a size increase of apparatus and cost increase.

In the above described above-described exemplary embodiments, dummy discharged ink or removed ink may be accumulated over multiple discontinuous areas along the rotation direction of the rotating member 126, by which waste ink may not accumulate at one position and thereby ink accumulation speed can be set slower.

The above-described waste ink treatment system can be employed for liquid jetting system, which may be devised as machines, apparatuses, systems, and methods using liquid for specific purposes and recovering used liquid. For example, the above-described waste ink treatment system may be employed for an image forming apparatus such as inkjet printer using recording liquid, but not limited these. Accordingly, the ink may mean any liquid used for specific purposes.

Numerous additional modifications and variations are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. A waste ink treatment system employed for a ink jetting system having a jetting head, comprising:
a rotating member, rotatable in a given rotation direction, to receive ink discharged from the jetting head, the discharged ink adhering to the rotating member; and
a scraping member disposed adjacent to the rotating member to remove the discharged ink adhering to the rotating member while the rotating member is being rotated, the scraping member dispersing the removed ink over multiple discontinuous areas along the rotation direction of the rotating member.

2. The waste ink treatment system according to claim 1, wherein the scraping member is shaped to disperse the removed ink over multiple discontinuous areas along the rotation direction of the rotating member.

3. The waste ink treatment system according to claim 1, wherein the scraping member includes a least a first scraping member and a second scraping member,
wherein the first scraping member is positioned at an upstream side of rotation direction of the rotating member and the second scraping member is positioned at a downstream side of rotation direction of the rotating member.

4. The waste ink treatment system according to claim 3, wherein a distance between the first scraping member and a circumferential face of the rotating member is same as a distance between the second scraping member and a circumferential face of the rotating member.

5. The waste ink treatment system according to claim 3, wherein a distance between the first scraping member and a circumferential face of the rotating member is greater than a distance between the second scraping member and a circumferential face of the rotating member.

6. The waste ink treatment system according to claim 3, wherein the first and second scraping members are positioned in a staggered manner with respect to a rotation axis direction of the rotating member.

7. The waste ink treatment system according to claim 1, wherein the scraping member is angled with respect to the rotation direction of the rotating member.

8. The waste ink treatment system according to claim 1, wherein the rotating member has a peripheral flange portion.

9. The waste ink treatment system according to claim 1, further comprising a waste ink tank to store ink removed by the scraping member, and the waste ink tank is removable from the waste ink treatment system.

10. The waste ink treatment system according to claim 9, wherein the waste ink tank is provided with a shutter that, when the waste ink tank is mounted to the waste ink treatment system, is set to an open position so that ink removed by the scraping member is stored in the waste ink tank, and when the waste ink tank is removed from the waste ink treatment system, is set to a close position.

11. The waste ink treatment system according to claim 10, wherein the shutter is provided with an absorber contactable with an outer face of the waste ink tank.

12. An image forming apparatus, comprising the waste ink treatment system according to claim 1.
